(19) United States
(12) Patent Application Publication
(10) Pub. No.: US 2026/0045169 A1
(43) Pub. Date: Feb. 12, 2026

(54) COMBINED AVIATION AND GROUND MAPPING FOR AIRCRAFT NAVIGATION

(71) Applicant: The Boeing Company, Arlington, VA (US)

(72) Inventors: Dragos M. Popescu, Phoenix, AZ (US); Julie A. Pruitt, Rockwall, TX (US); William Robert Bankwitz, Phoenix, AZ (US)

(21) Appl. No.: 18/801,213

(22) Filed: Aug. 12, 2024

(51) Int. Cl. G08G 5/02; G08G 5/00; G08G 5/06

(52) U.S. Cl. CPC G08G 5/54; G08G 5/21; G08G 5/34; G08G 5/51

(57) ABSTRACT

A computing system for combined aviation and ground mapping for aircraft navigation includes memory storing aviation map data, road map data, and instructions of an air-ground navigation program, and processing circuitry configured to implement the air-ground navigation program. The processing circuitry receives aircraft location data and destination data for a user of the aircraft. The destination data is cross-referenced with the road map data to validate a destination of the user, and a landing site proximate the destination is determined via the aviation map data. An air route segment from the location of the aircraft to the landing site and a ground route segment from the landing site to the destination are generated via respective algorithms. The air and ground route segments are combined to produce a combined air-ground navigation route, and a visual representation of the combined air-ground navigation route is output to a display device.

### FIELD

The present disclosure relates generally to a system for combining aviation map data and open source road map data to determine an optimal landing site for an aircraft.

### BACKGROUND

Aviation maps are a primary form of source information pertaining to flight planning in commercial and private air travel. These maps include topographical information, geographical landmarks, and coordinates, which are used to generate flight plan solutions for all aircraft types. Navigation systems and pilots relying only on aviation maps lack much of the information provided in road maps.

### SUMMARY

According to an example of the present disclosure, a computing system for combined aviation and ground mapping for aircraft navigation is provided. The computing system includes memory and processing circuitry. The memory stores aviation map data, road map data, and instructions of an air-ground navigation program. The processing circuitry is configured to implement the air-ground navigation program. The processing circuitry receives aircraft location data that indicates a current location of an aircraft and destination data that indicates a destination for a user of the aircraft. The destination data is cross-referenced with the road map data to validate the destination of the user, and a landing site proximate the destination is determined via the aviation map data. An air route generation algorithm is executed to generate an air route segment to be traveled by the aircraft from the current location of the aircraft to the landing site, and a ground route generation algorithm is executed to generate a ground route segment to be traveled over land from the landing site to the destination. The air route segment and the ground route segment are combined to produce a combined air-ground navigation route. A visual representation of the combined air-ground navigation route is output to a display device.

According to another example of the present disclosure, a method for combined aviation and ground mapping for aircraft navigation is provided. The method includes receiving aircraft location data that indicates a current location of the aircraft; receiving destination data that indicates a destination for a user of the aircraft; cross-referencing the destination data with the road map data to validate the destination of the user; determining, via the aviation map data, a landing site proximate the destination; executing an air route generation algorithm to generate an air route segment to be traveled by the aircraft from the current location of the aircraft to the landing site; executing a ground route generation algorithm to generate a ground route segment to be traveled over land from the landing site to the destination; combining the air route segment and the ground route segment to produce a combined air-ground navigation route; and outputting a visual representation of the combined air-ground navigation route to a display device.

According to another example of the present disclosure, a computing system for combined aviation and ground mapping for urban air motility navigation is provided. The computing system includes memory and processing circuitry. The memory stores aviation map data, road map data, and instructions for an air-ground navigation program. The processing circuitry is configured to implement the air-ground navigation program. The processing circuitry receives user origin data that indicates an origin of a passenger of an unmanned urban air motility passenger aircraft, aircraft location data that indicates a current location of an aircraft, and destination data that indicates a destination for the passenger of the aircraft. The origin data and the destination data are cross-referenced with the road map data to validate the origin and the destination of the passenger, and a landing site proximate the destination is determined via the aviation map data. A ground route generation algorithm is executed to generate a first ground route segment to be traveled over land from the origin to the boarding location, an air route generation algorithm is executed to generate an air route segment to be traveled by the aircraft from the current location of the aircraft to the landing site, and the ground route generation algorithm is executed to generate a second ground route segment to be traveled over land from the landing site to the destination. The first ground route segment, the air route segment, and the second ground route segment are combined to produce a combined air-ground navigation route. A visual representation of the combined air-ground navigation route is output to a display device.

### BRIEF DESCRIPTION OF THE DRAWINGS

FIG. 1 shows a schematic view of a computing system for combined aviation and ground mapping for aircraft navigation.

FIG. 2 shows a decision tree for an air-ground navigation program, in accordance with the computing system of FIG. 1.

FIGS. 3A and 3B show an aviation map and a ground map, respectively, in accordance with the computing system of FIG. 1.

FIG. 4A shows a combined air-ground navigation route including an air route segment and a ground route segment, in accordance with the computing system of FIG. 1.

FIG. 4B shows a combined air-ground navigation route in which an air route segment and a ground route segment are combined, in accordance with the computing system of FIG. 1.

FIG. 5 shows a schematic view of a passenger mobile computing device, in accordance with the computing system of FIG. 1.

FIG. 6 shows a ground route segment of a combined air-ground navigation route from an origin to an aircraft location, in accordance with the computing system of FIG. 1.

FIG. 7 shows a flow chart for a method for combined aviation and ground mapping for aircraft navigation according to an example implementation of the present disclosure.

### DETAILED DESCRIPTION

A computing system and method for combined aviation and ground mapping for aircraft navigation are disclosed herein. The system can be used, for example, to facilitate efficient travel by combining air travel with other travel methods in a single navigation route. The system and method have the potential to allow non-pilots to include air navigation in their travel plans, creating a more user-friendly interface and advancing the growth of the urban air mobility market.

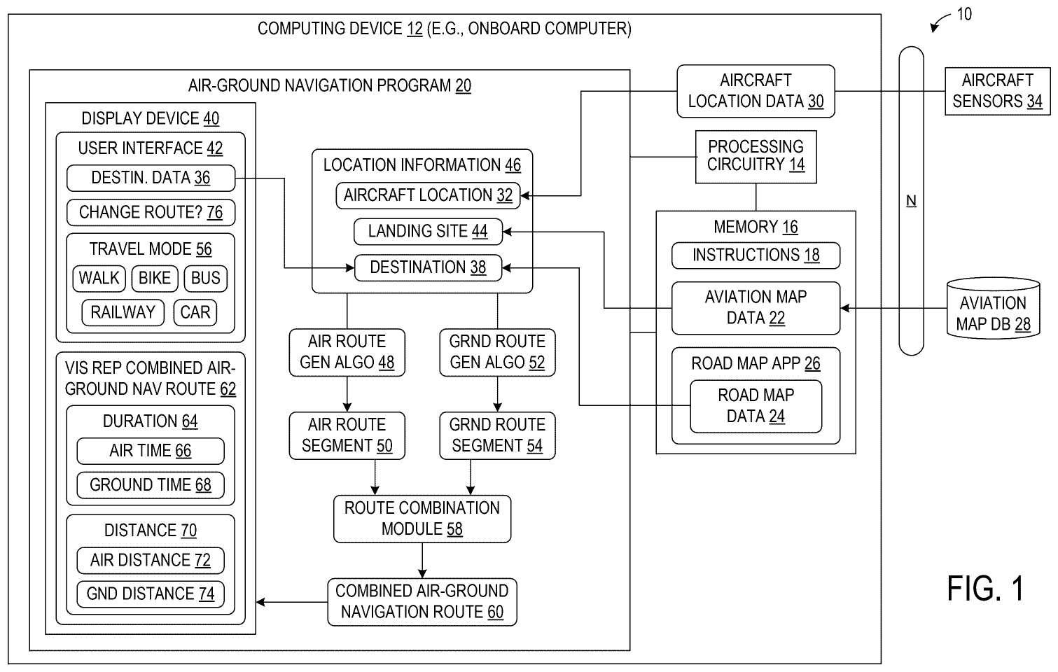

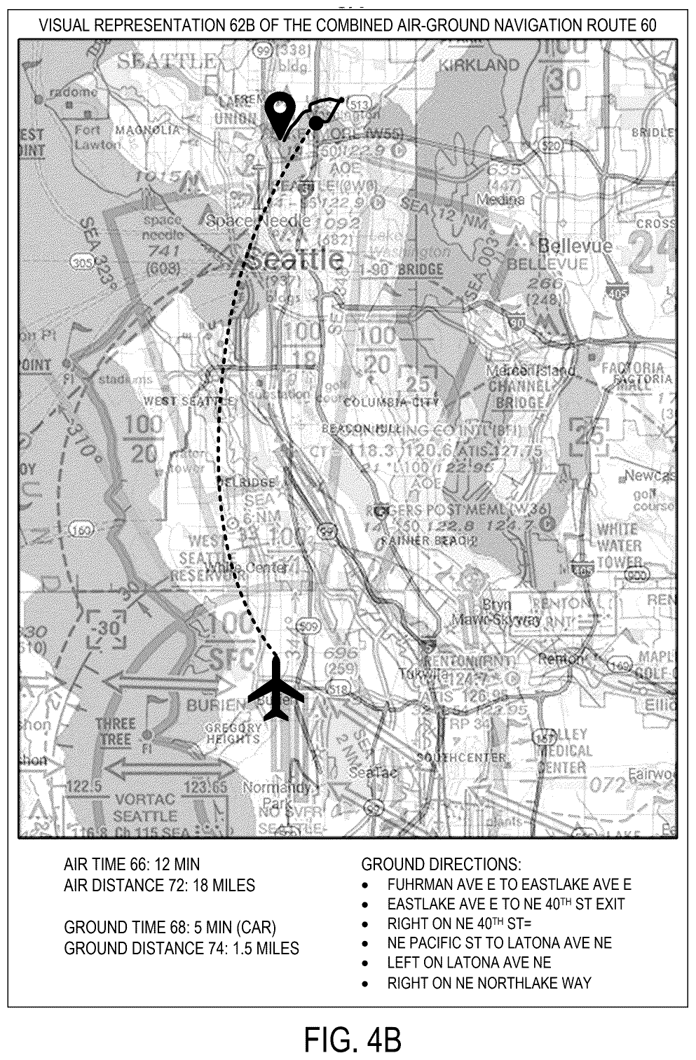

FIG. 1 shows a schematic view of an example computing system 10 for combined aviation and ground mapping for aircraft navigation. The computing system 10 is illustrated as having a computing device 12 including processing circuitry 14 and memory 16. In the embodiment described below, the computing device 12 will be described as an onboard computer. The illustrated implementation is exemplary in nature, and other configurations are possible. In some implementations, the system may include a second computing device, such as a passenger mobile computing device, as described in detail below with reference to FIG. 5. It will be appreciated that in other configurations, the computing system 10 may include additional or alternative computing devices, such as an offboard computing device, a client computing device, and/or a server. In other alternative configurations, functions described as being carried out at the onboard computer may alternatively be carried out at the passenger mobile computing device, the offboard computing device, the client computing device, the server, or a combination thereof.

Continuing with FIG. 1, the memory 16 stores instructions 18 of an air-ground navigation program 20, and the processing circuitry 14 is configured to execute the instructions 18 to implement the air-ground navigation program 20. At a high level, the air-ground navigation program 20 combines aviation map data 22 and road map data 24 from one or more open source road map applications 26 to improve flight plans such that ground travel time to the final destination is minimized.

The aviation map data 22, road map data 24, and one or more road map applications 26 are stored in the memory 16. The aviation map data 22 may be retrieved from an aviation map database 28 that is in communication with the onboard computer 12 via a network N. It will be appreciated that the aircraft described herein may be rotary wing aircraft, such as a traditional helicopter, a vertical-takeoff-and-landing aircraft (VTOL), an electrically propelled vertical-takeoff-and-landing aircraft (eVTOL), or an unmanned aerial vehicle (UAV). Thus, the aircraft may have a pilot, or it may be an autonomous or remotely piloted aircraft. Additionally or alternatively, the aircraft may be an urban air motility (UAM) passenger aircraft.

Upon implementation of the air-ground navigation program 20, the processing circuitry 14 is configured to receive aircraft location data 30 that indicates a current location 32 of an aircraft. The aircraft location data 30 may be received from aircraft sensors 34, such as an altimeter, an inertial reference unit (IRU) which includes gyroscopes and accelerometers, a global positioning system (GPS), and light detection and ranging (LiDAR). It will be appreciated that the altimeter merely provides an altitude of the aircraft and should not be solely relied upon for determining the location of the aircraft.

The processing circuitry 14 is additionally configured to receive destination data 36 that indicates a destination 38 for a user of the aircraft. The destination data 36 may be an address, an intersection, a set or coordinates, or the name of a business, a landmark, a point of interest, or the like. The onboard computer 12 may include a display device 40 with a user interface 42, and the destination data 36 may be entered by a user (i.e., pilot or passenger) via the user interface 42. Additionally or alternatively, the destination data may be entered on an offboard computing device, such as a personal smart device, for example, prior to flight time and uploaded to the onboard computer 12 when the user arrives at the aircraft. Once received, the destination data 36 is cross-referenced with the road map data 24 to validate the destination 38 of the user. Validation of the destination 38 may include determining GPS coordinates for the destination data 36 when an address, intersection, or name of a business, a landmark, or a point of interest is received.

Once the destination 38 is validated, a landing site 44 for the aircraft proximate the destination 38 is determined via the aviation map data 22. To ensure accuracy between the GPS coordinates of the destination 38 translated from the open source road map data 24 and the landing site 44 for aircraft based on the aviation map data 22, a verification process is performed. Together, the aircraft location 32, destination 38, and landing site 44 comprise location information 46 for the air-ground navigation program 20. Accessing the location information 46, the processing circuitry 14 executes an air route generation algorithm 48 to generate an air route segment 50 to be traveled by the aircraft from the current location 32 of the aircraft to the landing site 44. When more than one landing site 44 is identified and/or more than one flight path is identified, the air route generation algorithm 48 may score the multiple routes based on real time weather information, real time air traffic information, and real time air traffic control instructions, for example.

A ground route generation algorithm 52 is executed to generate a ground route segment 54 to be traveled over land from the landing site 44 to the destination 38. As with the air route generation algorithm 48, the ground route generation algorithm 52 is configured to consider conditions such as real time ground traffic and distance of the route when scoring potential ground route segments 54. To further ensure accuracy of the ground route segment 54, the processing circuitry 14 receives a travel mode 56 for the ground route segment 54, which is selected from walk, bicycle, bus, railway, and car, as shown in FIG. 1.

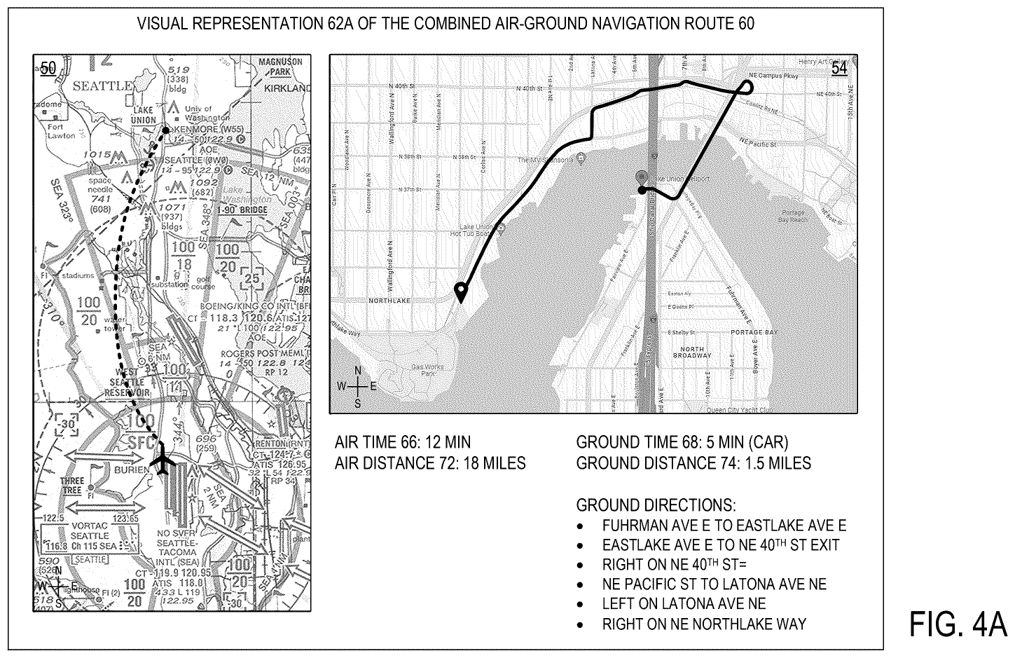

The air route segment 50 and the ground route segment 54 are sent to a route combination module 58 where they are combined to generate a combined air-ground navigation route 60. A visual representation 62 of the combined air-ground navigation route 60 is output to the display device 40. As described below and shown in FIGS. 4A and 4B, the visual representation 62 of the combined air-ground navigation route 60 may include one or more maps, text directions, duration, distance, or a combination thereof.

For example, as shown in FIG. 1, an estimated duration 64 for the combined air-ground navigation route 60 may be displayed on the display device 40, and the estimated duration 64 may include an air travel time 66 for the air route segment 50 and a ground travel time 68 for the ground route segment 54. Additionally, a travel distance 70 for the combined air-ground navigation route 60 may be displayed on the display device 40, and the travel distance 70 may include an air travel distance 72 for the air route segment 50 and a ground travel distance 74 for the ground route segment 54.

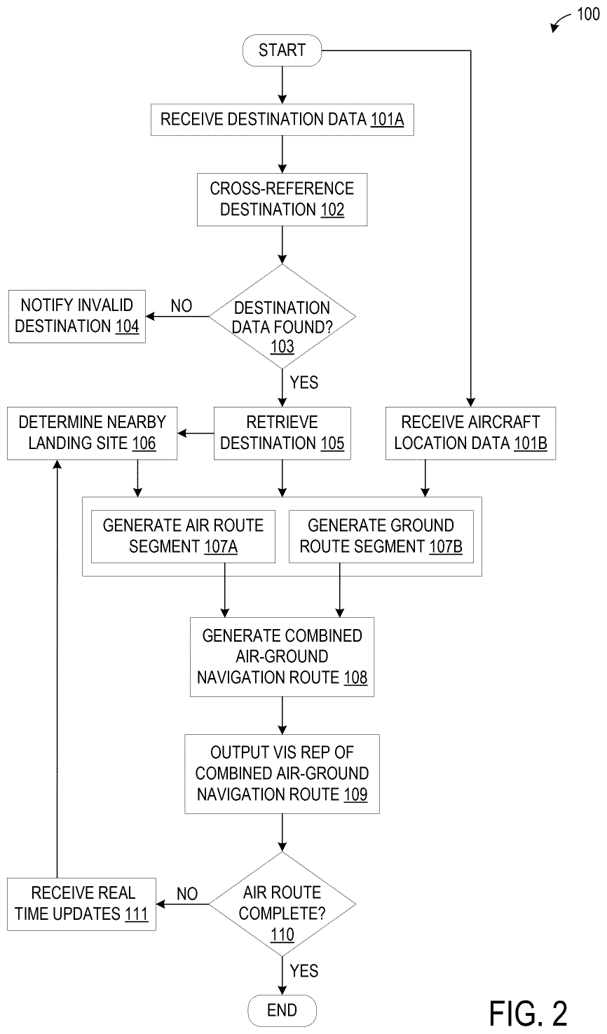

As described below with respect to FIG. 2, during travel of the aircraft on the air route segment 50 of the combined air-ground navigation route 60, the processing circuitry 14 is configured to receive real time updates to the aviation map data 22 and road map data 24. As discussed above, the real time updates may be based on real time ground traffic information, real time weather information, real time air traffic information, real time air traffic control instructions, and the like. For example, a landing location that provides a shorter overall travel time due to ground traffic congestion may be available. When an alternate landing site is identified based on the real time updates, a prompt 76 for an option to change the combined air-ground navigation route 60 to land at the alternate landing site is presented to the user via the user interface 42.

It will be appreciated that any modifications to the combined air-ground navigation route 60 during the air route segment 50 that include a change in landing site will necessitate modifications to the ground route segment 54 as well. Similarly, changes to the landing site during travel on the air route segment 50 of the trip may result in modifications to the air route segment 50 if the modifications result in selection of a different landing site. However, modifications to the ground route segment 54 after the air travel portion is complete will have no effect on the air route segment 50. When processing the air route segment 50, the air-ground navigation program 20 will generate combined air-ground navigation routes 60 using respective class airspace according to flight class regulations.

Turning to FIG. 2, a decision tree 100 for the air-ground navigation program 20 is shown. The decision tree 100 substantially maps to the system 10 as described above with respect to FIG. 1. At steps 101A and 101B of the decision tree 100, the destination data 36 and the aircraft sensor data 30 are received. The destination data 36 is cross-referenced with the road map data 24 to validate the destination 38 for the user of the aircraft at step 102. At step 103, the program 20 queries if the destination data 36 is found in the road map data 24. If the outcome is NO, the decision moves to step 104, and the user is notified that the input destination data is invalid. If the outcome is YES, the decision advances to step 105, and the destination 38 is retrieved from the road map data 24. At step 106, the landing site 44 near the destination 38 is determined via aviation map data 22. At steps 107A and 107B, the air route segment 50 and the ground route segment 54 are generated by the air route generation algorithm 48 and the ground route generation algorithm 52, respectively. At step 108, the air route segment 50 and the ground route segment 54 are combined to generate the combined air-ground navigation route 60. At step 109, the visual representation 62 of the combined air-ground navigation route 60 is output to the display device 40. At step 110, during the air route segment 50 of the combined air-ground navigation route 60, the program 20 will periodically query if the air route is complete. If the outcome is NO, the program 20 will continue to receive real time updates based as described above. When the outcome is YES and the aircraft has landed, the program 20 will end. As the ground route segment 54 of the navigation program 20 is completed independently of the onboard computer 12 and its display device 40, a map and/or instructions for the ground route segment 54 may be provided to the user/passenger via transmission to a mobile computing device or printed on paper, for example.

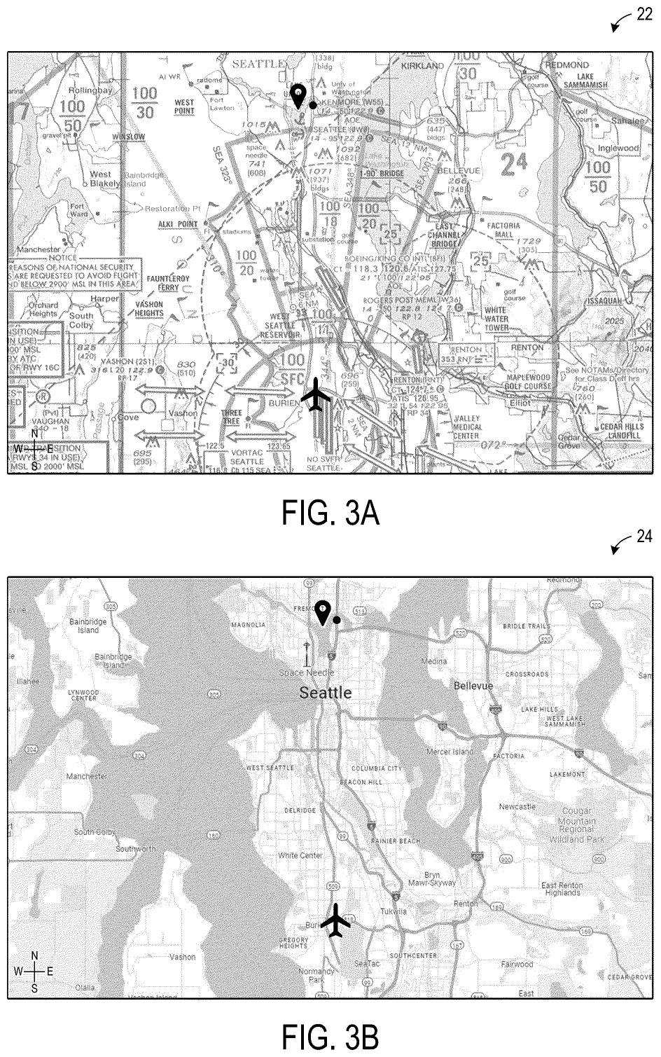

FIGS. 3A-6 depict an example use-case scenario of the combined air-ground navigation program 20. Beginning with FIG. 3A, an example of aviation map data 22, i.e., an aviation chart, is shown. The illustrated aviation chart is a section of a visual flight rules (VFR) terminal area chart (TAC) that portrays a metropolitan area. An example of road map data 24, i.e., a road map, is shown in FIG. 3B. The scale of the road map is adjusted to match the section of the VFR TAC shown in FIG. 3A. In both FIGS. 3A and 3B, the airplane icon represents the aircraft location 32 at an international airport, and the landing site 44 and destination 38 are shown to the north of the aircraft location 32 as a dot and location pin icon, respectively. The landing site 44 is a helicopter pad, and the destination is a park.

FIGS. 4A and 4B show visual representations 62A, 62B of the example combined air-ground navigation route 60, which may include one or more maps, text directions, duration, distance, or a combination thereof. In the left panel of FIG. 4A, the air route segment 50 is depicted as an aviation map showing a flight path for the aircraft from the current location 32 of the aircraft at the airport to the landing site 44. The panel on the right in FIG. 4A shows the ground route segment 54 as a road map with the route indicated on the map. The scale of the road map is enlarged with respect to the scale of the aviation chart, as the area of travel is much smaller.

FIG. 4B shows the visual representation 62B of the example combined air-ground navigation route 60 with the aviation map overlaying the road map such that both the air route segment 50 and the ground route segment 54 can be seen together in a single output.

In both of the visual representations 62A, 62B, the air time 66, air distance 72, ground time 68, and ground distance 74 are shown, with the ground travel mode 56 being by car. Also provided are text directions for the ground route segment 54. It will be appreciated that the visual representations 62A, 62B of the combined air-ground navigation route 60 shown in FIGS. 4A and 4B are exemplary in nature and not intended to limit the scope of the visual representations 62 of the combined air-ground navigation route 60 to the illustrated embodiments. For example, the visual representation of the combined air-ground navigation route 60 may include the air route segment 50 and the ground route segment 54 separately, as well as the air route segment 50 and the ground route segment 54 in the same map.

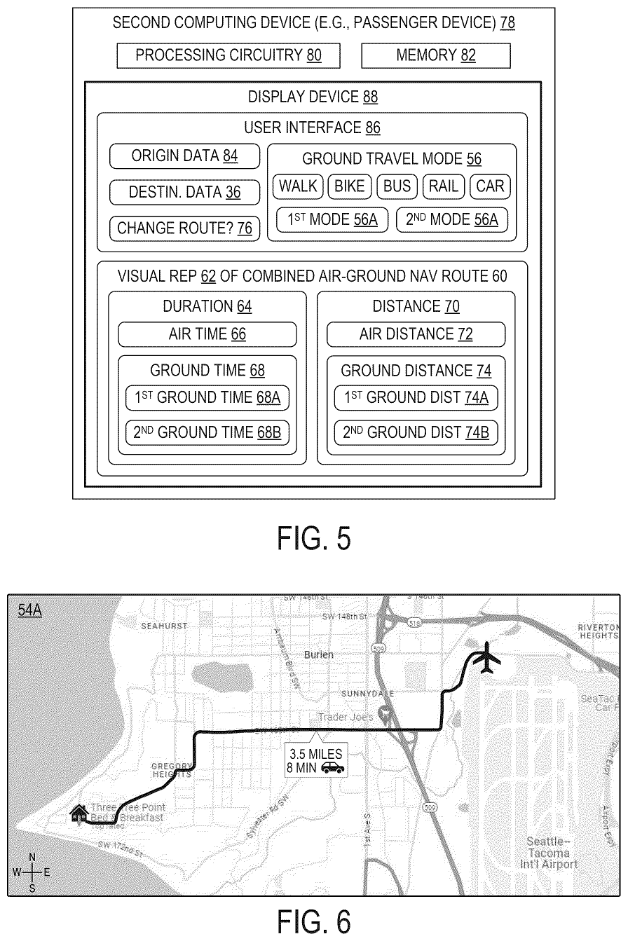

As briefly discussed above with respect to FIG. 1, in some implementations, the system 10 may include a second computing device, such as a passenger mobile computing device. Additionally, in some implementations, the air-ground navigation program 20 may be configured to generate a combined air-ground navigation route 60 that begins at a designated origin of a passenger. FIGS. 5 and 6 are directed to an implementation that includes a passenger mobile computing device and in which the combined air-ground navigation route 60 begins at the origin of the passenger. Because the generation of combined air-ground navigation route 60 has been discussed in detail above, only the differences pertaining to the passenger mobile computing device and the origin will be described in detail here for the sake of brevity.

FIG. 5 shows a schematic view of a passenger mobile computing device 74. The passenger mobile computing device 74 includes processing circuitry 76 and memory 78. The memory 78 may store instructions for passenger use of the air-ground navigation program 20, such as the ability to enter origin and destination data, select ground travel modes 56, change routes when prompted during the air route segment 50, and view visual representations 62 of combined air-ground navigation routes 60, including durations 64 and distances 70.

Origin data 80 that indicates an origin of a passenger of the aircraft and the destination data 36 are input to the passenger mobile computing device 74 by the passenger via a user interface 82 of a display device 84 of the passenger mobile computing device 74. The processing circuitry 14 of the onboard computer 12 is configured to receive user origin data 80 and the destination data 36, which are communicated to the onboard computing device 12 via the computer network N. As with the destination data, the processing circuitry 14 cross-references the origin data 80 with the road map data 24 to validate the origin of the passenger. The ground route generation algorithm 52 is executed to generate a first ground route segment 54A to be traveled over land from the origin to the aircraft location 32, as well as a second ground route segment 54B to be traveled over land from the landing site 44 to the destination 38. The passenger may select a first travel mode 56A for the first ground route segment 54A and a second travel mode 56B for the second ground route segment 54B via the user interface 82 of the passenger mobile computing device 74. The first ground segment 54A, the air route segment 50, and the second ground route segment 54B are combined to produce the combined air-ground navigation route 60.

An example of the first ground route segment 54A of the visual representation 62 of the combined air-ground navigation route 60 output to the display device 84 of the passenger mobile computing device 74 is shown in FIG. 6. The house icon represents the origin of the passenger, and the airplane icon represents the aircraft location 32 at the international airport. The route from the origin to the aircraft location 32 is indicated with a dark line, and the ground distance, ground travel time, and travel mode are indicated in a rectangular callout.

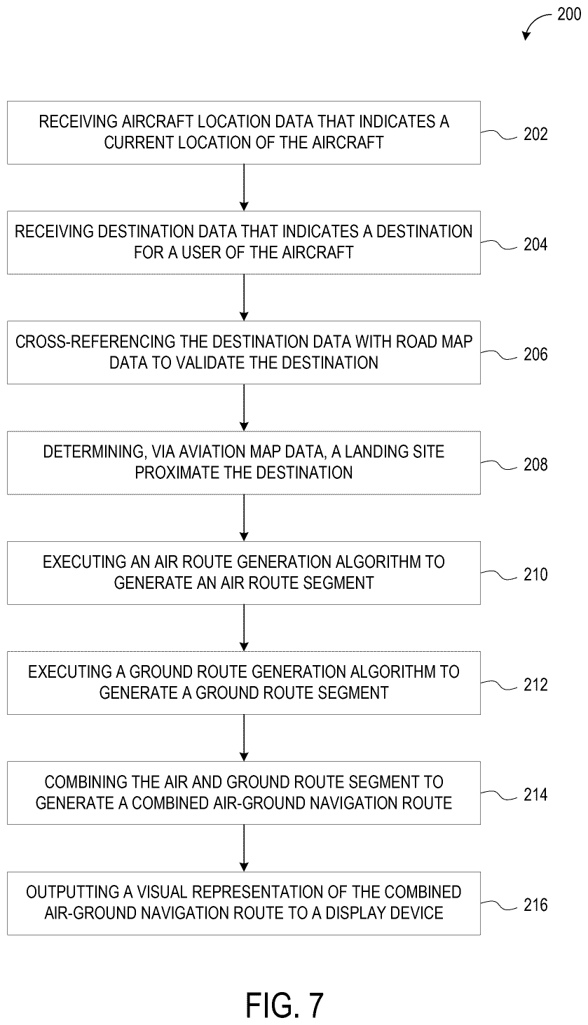

FIG. 7 is a flow chart depicting an example method 200 for combined aviation and ground mapping for aircraft navigation. The following description of method 200 is provided with reference to the computing system 10 for combined aviation and ground mapping for aircraft navigation described herein and shown in FIGS. 1-6. However, it will be appreciated that method 200 or portions thereof can be performed in other contexts using other suitable components.

With reference to FIG. 7, at step 202, the method 200 includes receiving aircraft location data 30 that indicates a current location 32 of the aircraft. As described in detail above, the aircraft location data 30 may be received from aircraft sensors 34, such as an altimeter, an inertial reference unit (IRU) which includes gyroscopes and accelerometers, a global positioning system (GPS), and light detection and ranging (LiDAR).

At step 204, the method 200 includes receiving destination data 36 that indicates a destination 38 for a user of the aircraft. As described in detail above, the destination data 36 may be an address, an intersection, a set or coordinates, or the name of a business, a landmark, a point of interest, or the like. The onboard computer 12 may include a display device 40 with a user interface 42, and the destination data 36 may be entered by a user (i.e., pilot or passenger) via the user interface 42.

At step 206, the method 200 includes cross-referencing the destination data 36 with road map data 24 to validate the destination 38 of the user.

At step 208, the method 200 includes determining, via aviation map data 22, a landing site 44 proximate the destination 38.

At step 210, the method 200 includes executing an air route generation algorithm 48 to generate an air route segment 50 to be traveled by the aircraft from the current location 32 of the aircraft to the landing site 44. As described in detail above, when more than one landing site 44 is identified and/or more than one flight path is identified, the air route generation algorithm 48 may score the multiple routes based on real time weather information, real time air traffic information, and real time air traffic control instructions, for example.

At step 212, the method 200 includes executing a ground route generation algorithm 52 to generate a ground route segment 54 to be traveled over land from the landing site 44 to the destination 38. As described in detail above, the ground route generation algorithm 52 is configured to consider conditions such as real time ground traffic and distance of the route when scoring potential ground route segments 54. To further ensure accuracy of the ground route segment 54, the processing circuitry 14 receives a travel mode 56 for the ground route segment 54, which is selected from walk, bicycle, bus, railway, and car.

At step 214, the method 200 includes combining the air route segment 50 and the ground route segment 54 to generate a combined air-ground navigation route 60.

At step 216, the method 200 includes outputting a visual representation 62 of the combined air-ground navigation route 60 to a display device 40. As described in detail above, the visual representation 62 of the combined air-ground navigation route 60 may include one or more maps, text directions, duration, distance, or a combination thereof. For example, an estimated duration 64 for the combined air-ground navigation route 60 may be displayed on the display device 40, and the estimated duration 64 may include an air travel time 66 for the air route segment 50 and a ground travel time 68 for the ground route segment 54. Additionally, a travel distance 70 for the combined air-ground navigation route 60 may be displayed on the display device 40, and the travel distance 70 may include an air travel distance 72 for the air route segment 50 and a ground travel distance 74 for the ground route segment 54.

Further, the disclosure comprises configurations according to the following examples.

Example 1. A computing system for combined aviation and ground mapping for aircraft navigation, the computing system comprising: memory storing aviation map data, road map data, and instructions of an air-ground navigation program; and processing circuitry configured to implement the air-ground navigation program, thereby causing the processing circuitry to: receive aircraft location data that indicates a current location of an aircraft; receive destination data that indicates a destination for a user of the aircraft; cross-reference the destination data with the road map data to validate the destination of the user; determine, via the aviation map data, a landing site proximate the destination; execute an air route generation algorithm to generate an air route segment to be traveled by the aircraft from the current location of the aircraft to the landing site; execute a ground route generation algorithm to generate a ground route segment to be traveled over land from the landing site to the destination; combine the air route segment and the ground route segment to generate a combined air-ground navigation route; and output a visual representation of the combined air-ground navigation route to a display device.

Example 2. The computing system of example 1, wherein an estimated duration for the combined air-ground navigation route is displayed on the display device.

Example 3. The computing system of example 2, wherein the estimated duration includes an air travel time for the air route segment and a ground travel time for the ground route segment.

Example 4. The computing system of any one of examples 1-3, wherein a travel distance for the combined air-ground navigation route is displayed on the display device.

Example 5. The computing system of example 4, wherein the travel distance includes an air travel distance for the air route segment and a ground travel distance for the ground route segment.

Example 6. The computing system of any one of examples 1-5, wherein the display device includes a user interface, during travel of the aircraft on the air route segment of the combined air-ground navigation route, the processing circuitry receives real time updates to the aviation map data and road map data, and when an alternate landing site is identified based on the real time updates, an option to change the combined air-ground navigation route to land at the alternate landing site is presented to the user via the user interface.

Example 7. The computing system of any one of examples 1-6, wherein the aircraft is an autonomous or remotely piloted aircraft.

Example 8. The computing system of any one of examples 1-7, wherein the processing circuitry further receives a travel mode for the ground route segment, the travel mode being selected from walk, bicycle, bus, railway, and car.

Example 9. A method for combined aviation and ground mapping for aircraft navigation, the method comprising: receiving aircraft location data that indicates a current location of the aircraft; receiving destination data that indicates a destination for a user of the aircraft; cross-referencing the destination data with road map data to validate the destination of the user; determining, via aviation map data, a landing site proximate the destination; executing an air route generation algorithm to generate an air route segment to be traveled by the aircraft from the current location of the aircraft to the landing site; executing a ground route generation algorithm to generate a ground route segment to be traveled over land from the landing site to the destination; combining the air route segment and the ground route segment to generate a combined air-ground navigation route; and outputting a visual representation of the combined air-ground navigation route to a display device.

Example 10. The method of example 9, the method further including: displaying an estimated duration for the combined air-ground navigation route on the display device.

Example 11. The method of example 10, the method further including: including in the estimated duration an air travel time for the air route segment and a ground travel time for the ground route segment.

Example 12. The method of any one of examples 9-11, the method further including: displaying a travel distance for the combined air-ground navigation route on the display device.

Example 13. The method of example 12, the method further including: including in the travel distance an air travel distance for the air route segment and a ground travel distance for the ground route segment.

Example 14. The method of any one of examples 9-13, the method further including: including a user interface in the display device, receiving real time updates to the aviation map data and the road map data during travel of the aircraft on the air route segment of the combined air-ground navigation route, and when an alternate landing site is identified based on the real time updates, presenting an option to change the combined air-ground navigation route to land at the alternate landing site to the user via the user interface.

Example 15. The method of any one of examples 9-14, wherein the aircraft is an autonomous or remotely piloted aircraft.

Example 16. The method of any one of examples 9-15, the method further including: receiving a travel method for the ground route segment, the travel method being selected from walk, bicycle, bus, railway, and car.

Example 17. A computing system for combined aviation and ground mapping for urban air motility navigation, the computing system comprising: memory storing aviation map data, road map data, and instructions of an air-ground navigation program; and processing circuitry configured to implement the air-ground navigation program, thereby causing the processing circuitry to: receive user origin data that indicates an origin of a passenger of an autonomous or remotely piloted urban air motility passenger aircraft; receive aircraft location data that indicates a boarding location of the aircraft; receive destination data that indicates a destination of the passenger of the aircraft; cross-reference the origin data with the road map data to validate the origin of the passenger; cross-reference the destination data with the road map data to validate the destination of the passenger; execute a ground route generation algorithm to generate a first ground route segment to be traveled over land from the origin to the boarding location; execute an air route generation algorithm to generate an air route segment to be traveled by the aircraft from the current location of the aircraft to the landing site; execute the ground route generation algorithm to generate a second ground route segment to be traveled over land from the landing site to the destination; combine the first ground segment, the air route segment, and the second ground route segment to produce a combined air-ground navigation route; and output a visual representation of the combined air-ground navigation route to a display device.

Example 18. The computing system of example 17, wherein the origin data and the destination data are input to a passenger mobile computing device by the passenger of the unmanned urban air motility passenger aircraft, the processing circuitry of the computing system is a computing device on board the aircraft, and the origin data and destination data are communicated to the onboard computing device via a computer network.

Example 19. The computing system of example 17 or 18, wherein the visual representation of the navigation route is output to the display device of a passenger mobile computing device of the passenger of the autonomous or remotely piloted urban air motility passenger aircraft.

Example 20. The computing system of any one of examples 17-19, wherein the processing circuitry further receives a first travel mode for the first ground route segment and a second travel mode for the second ground route segment, the first and second travel modes being selected from walk, bicycle, bus, railway, and car.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for combined aviation and ground mapping for aircraft navigation, the computing system comprising:
memory storing aviation map data, road map data, and instructions of an air-ground navigation program; and
processing circuitry configured to implement the air-ground navigation program, thereby causing the processing circuitry to:
receive aircraft location data that indicates a current location of an aircraft;
receive destination data that indicates a destination for a user of the aircraft;
cross-reference the destination data with the road map data to validate the destination of the user;
determine, via the aviation map data, a landing site proximate the destination;
execute an air route generation algorithm to generate an air route segment to be traveled by the aircraft from the current location of the aircraft to the landing site;
execute a ground route generation algorithm to generate a ground route segment to be traveled over land from the landing site to the destination;
combine the air route segment and the ground route segment to generate a combined air-ground navigation route; and
output a visual representation of the combined air-ground navigation route to a display device.

2. The computing system of claim 1, wherein
an estimated duration for the combined air-ground navigation route is displayed on the display device.

3. The computing system of claim 2, wherein
the estimated duration includes an air travel time for the air route segment and a ground travel time for the ground route segment.

4. The computing system of claim 1, wherein
a travel distance for the combined air-ground navigation route is displayed on the display device.

5. The computing system of claim 4, wherein
the travel distance includes an air travel distance for the air route segment and a ground travel distance for the ground route segment.

6. The computing system of claim 1, wherein
the display device includes a user interface,
during travel of the aircraft on the air route segment of the combined air-ground navigation route, the processing circuitry receives real time updates to the aviation map data and road map data, and
when an alternate landing site is identified based on the real time updates, an option to change the combined air-ground navigation route to land at the alternate landing site is presented to the user via the user interface.

7. The computing system of claim 1, wherein
the aircraft is an autonomous or remotely piloted aircraft.

8. The computing system of claim 1, wherein
the processing circuitry further receives a travel mode for the ground route segment, the travel mode being selected from walk, bicycle, bus, railway, and car.

9. A method for combined aviation and ground mapping for aircraft navigation, the method comprising:
receiving aircraft location data that indicates a current location of the aircraft;
receiving destination data that indicates a destination for a user of the aircraft;
cross-referencing the destination data with road map data to validate the destination of the user;
determining, via aviation map data, a landing site proximate the destination;
executing an air route generation algorithm to generate an air route segment to be traveled by the aircraft from the current location of the aircraft to the landing site;
executing a ground route generation algorithm to generate a ground route segment to be traveled over land from the landing site to the destination;
combining the air route segment and the ground route segment to generate a combined air-ground navigation route; and
outputting a visual representation of the combined air-ground navigation route to a display device.

10. The method of claim 9, the method further including:
displaying an estimated duration for the combined air-ground navigation route on the display device.

11. The method of claim 10, the method further including:
including in the estimated duration an air travel time for the air route segment and a ground travel time for the ground route segment.

12. The method of claim 9, the method further including:
displaying a travel distance for the combined air-ground navigation route on the display device.

13. The method of claim 12, the method further including:
including in the travel distance an air travel distance for the air route segment and a ground travel distance for the ground route segment.

14. The method of claim 9, the method further including:
including a user interface in the display device,
receiving real time updates to the aviation map data and the road map data during travel of the aircraft on the air route segment of the combined air-ground navigation route, and
when an alternate landing site is identified based on the real time updates, presenting an option to change the combined air-ground navigation route to land at the alternate landing site to the user via the user interface.

15. The method of claim 9, wherein
the aircraft is an autonomous or remotely piloted aircraft.

16. The method of claim 9, the method further including:
receiving a travel method for the ground route segment, the travel method being selected from walk, bicycle, bus, railway, and car.

17. A computing system for combined aviation and ground mapping for urban air motility navigation, the computing system comprising:
memory storing aviation map data, road map data, and instructions of an air-ground navigation program; and
processing circuitry configured to implement the air-ground navigation program, thereby causing the processing circuitry to:
receive user origin data that indicates an origin of a passenger of an autonomous or remotely piloted urban air motility passenger aircraft;
receive aircraft location data that indicates a boarding location of the aircraft;
receive destination data that indicates a destination of the passenger of the aircraft;
cross-reference the origin data with the road map data to validate the origin of the passenger;
cross-reference the destination data with the road map data to validate the destination of the passenger;
execute a ground route generation algorithm to generate a first ground route segment to be traveled over land from the origin to the boarding location;
execute an air route generation algorithm to generate an air route segment to be traveled by the aircraft from the current location of the aircraft to the landing site;
execute the ground route generation algorithm to generate a second ground route segment to be traveled over land from the landing site to the destination;
combine the first ground segment, the air route segment, and the second ground route segment to produce a combined air-ground navigation route; and
output a visual representation of the combined air-ground navigation route to a display device.

18. The computing system of claim 17, wherein
the origin data and the destination data are input to a passenger mobile computing device by the passenger of the unmanned urban air motility passenger aircraft,
the processing circuitry of the computing system is a computing device on board the aircraft, and
the origin data and destination data are communicated to the onboard computing device via a computer network.

19. The computing system of claim 17, wherein
the visual representation of the navigation route is output to the display device of a passenger mobile computing device of the passenger of the autonomous or remotely piloted urban air motility passenger aircraft.

20. The computing system of claim 17, wherein
the processing circuitry further receives a first travel mode for the first ground route segment and a second travel mode for the second ground route segment, the first and second travel modes being selected from walk, bicycle, bus, railway, and car.
